(19) United States
(12) Patent Application Publication
(10) Pub. No.: US 2026/0109805 A1
(43) Pub. Date: Apr. 23, 2026

(54) AMMONIUM POLYPHOSPHATE LOADED PARTICLES AS A FLAME RETARDANT IN POLYMER COMPOSITIONS

(71) Applicant: UNIVERSITEIT TWENTE, Enschede (NL)

(72) Inventors: Stefan Peil, Enschede (NL); Frederik Roman Wurm, Enschede (NL)

(21) Appl. No.: 19/165,832

(22) PCT Filed: Mar. 14, 2024
(86) PCT No.: PCT/EP2024/056796

§ 371 Date: Sep. 16, 2025

(30) Foreign Application Priority Data
Mar. 16, 2023 (NL) 2034365

(51) Int. Cl. C08G 18/64; C08J 9/00; C08K 3/32; C08K 9/10

(52) U.S. Cl. CPC C08G 18/6492; C08J 9/0038; C08J 9/0061; C08K 3/32; C08K 9/10; C08J 2497/00; C08K 2003/323

(57) ABSTRACT

Particles having a core including a water soluble flame retardant, such as ammonium polyphosphate and a shell including polyphenols, such as lignosulfonates. These particles may be used as flame retardants, in particular in polymer foams.

### FIELD OF THE INVENTION

The present invention relates to particles comprising a core comprising a water-soluble flame retardant such as ammonium polyphosphate and a shell comprising polyphenols, to the use of these particles as flame retardants, to a method for producing the particles, to a polymer composition or foam produced by the method, and to use of the polymer composition or foam for the production of flame retardant products.

### BACKGROUND OF THE INVENTION

Organic polymers are flammable. In many polymer applications, such as in fibres, foams, and electrical enclosures, fire protection is therefore required in the form of added flame retardants. Polymer foams are used, for example, in the furniture industry as seat cushions or generally as energy absorbent, or noise and heat insulation materials. Especially in polymer foams, the large surface area per unit mass of such polymers exacerbates the flammability, enlarging the requirement for flame retardants. There are flame retardants that smother the flame in the gas phase and there are flame retardants that protect the surface of the polymeric material by promoting charring or forming a glassy coating. Halogen-containing compounds and nitrogen and phosphorus compounds are preferred flame retardants. Compounds containing halogens and low-valent phosphorus compounds are considered typical representatives of flame retardants that smother flames. Higher-valent phosphorus compounds may cause catalytic cleavage of polymers, leading to the formation of a solid, polyphosphate-containing charred surface or to the formation of a porous carbonaceous surface foam. Both types of layers protect the material from further combustion.

Usually, mixtures of flame retardants are used to reduce the flammability of polymers. For example, mixtures of phosphoric trichloropropyl ester (TCPP), phosphoric tris(dichloropropyl) ester (TDCPP) and/or melamine may be used.

A disadvantage of using melamine is that it is not harmless to health and, as a solid, may be insoluble in the raw materials used. Stirring powder into liquid raw materials and its tendency to sedimentation therefore make industrial processing difficult. Liquid flame retardants such as TCPP do not have this disadvantage. On the contrary, compounds such as TCPP are relatively volatile and thus able to interfere with the radical chain reaction taking place in a flame. This results in the temperature of the flame being reduced, which in turn reduces the decomposition of the ignited material. However, one disadvantage of the halogen-containing representatives of these classes in particular is that they can also migrate out of the polymer due to their volatility, thereby producing corrosive hydrohalic acid when used in a combustion process.

The disadvantages mentioned can be partially compensated for by the use of the well-known flame retardant ammonium polyphosphate (APP). However, in order to achieve an optimum performance, APP needs to be properly dispersed into the polymer. This is often impossible due to incompatibility with the polymer system. Furthermore, solubility of APP in water reduces weathering performance of the material. To reduce these effects, protective coatings have been applied to the APP particles. For example, CN104817676 discloses particles with an APP core and a shell of melamine-based polymers. CN104448394 describes the use of hydroxy-functional acrylates as a shell. However, the beforementioned coated APP particles are not necessarily suitable for use in other polymer systems, such as poly lactic acid (PLA), polystyrene (PS), polyamides (PA), polyethylene (PE) and polypropylene (PP) and many other polymers.

### SUMMARY OF THE INVENTION

It is an object of the present invention to provide a sedimentation-stable and well-dispersed flame retardant which leads to improved flame retardancy of polymers, such as liquid polymer resins, solid polymer composites and polymer foams. Preferably, the use of the well-dispersed, sedimentation-stable flame retardant can reduce or even replace the amount of halogen-containing flame retardants. It is a further object of the present invention to provide a well-dispersed, sedimentation-stable flame retardant which can be made compatible with a variety of different polymers.

Thereto, the present invention provides particles comprising, preferably consisting of, a core comprising a water-soluble flame retardant and a shell comprising polyphenols, preferably bio-based polyphenols. The invention relates to a method for producing these particles (also referred to as capsules), to use of these particles as flame retardants, to a method for producing a flame retardant polymer composition or foam with these particles, to a polymer composition or foam produced by this method, and use of the polymer composition or foam for the production of several articles.

### BRIEF DESCRIPTION OF THE FIGURES

FIG. 1 shows a schematic picture of a method according to the invention.

FIG. 2 shows a DLS graph of particles with an APP core and a lignin shell (LP) in cyclohexane (average from 3 measurements, Z-average=240 nm, PDI=0.13).

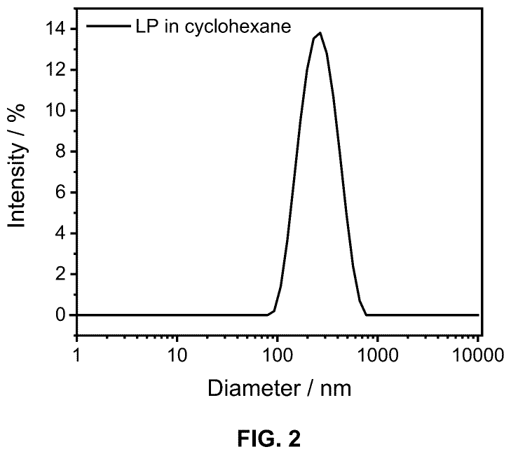

FIG. 3 shows electron microscopy images of LP (left: SEM, right: TEM).

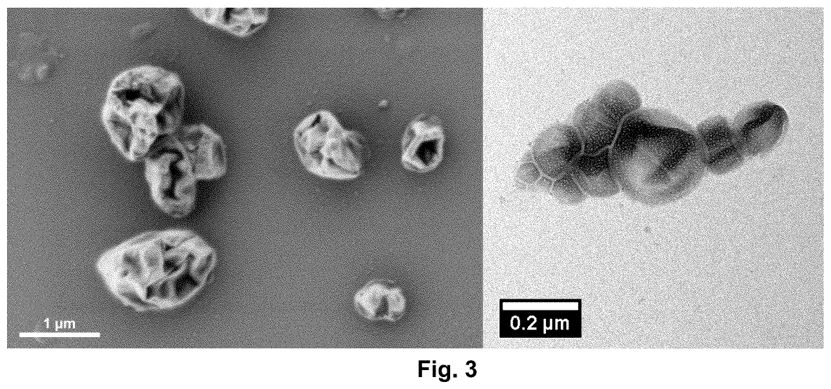

FIG. 4 shows SEM images of CO₂-blown PLA foams loaded with 13% LP (top: overview, bottom left: zoom in, bottom right: backscattering image wherein light areas indicate presence of phosphorus).

### DETAILED DESCRIPTION OF THE INVENTION

The invention provides particles comprising, preferably consisting of, a core comprising a water-soluble flame retardant and a shell comprising polyphenols, preferably bio-based polyphenols. Preferably, the water-soluble flame retardant has a water solubility of at least 1 g/mL @ 25° C., more preferably of at least 1.2 g/mL @ 25° C. Preferably, the amount of the core of the particles amounts to 65-95% by weight and the amount of the shell amounts to 5-35% by weight, based on the total weight of the core and the shell of the particles. More preferably, the amount of the core amounts to 66-90%, such as 67-85%, by weight and the amount of the shell to 10-34%, such as 15-33% by weight, based on the total weight of the core and the shell of the particles.

Preferably, the water-soluble flame retardant is a polyphosphate, such as an alkali polyphosphate, e.g. magnesium, sodium or potassium polyphosphate or ammonium polyphosphate. More preferably, the water-soluble flame retardant is ammonium polyphosphate. Most preferably the ammonium polyphosphate of the core of the particles corresponds to formula (I).

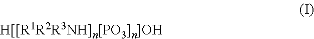

wherein R¹ to R³ each independently represent H or a substituted or unsubstituted alkyl group, preferably an alkyl group having 1 to 8 carbon atoms, and n is an integer from 4 to 20.

Particularly preferred are water-soluble ammonium polyphosphates according to formula (I) in which R¹ to R³ independently represent H, CH₃ or CH₂CH₃ and n is an integer from 4 to 20.

Preferably, the ammonium polyphosphate (APP) is phase I APP (i.e. linear or non-branched APP). Preferably the APP has a water solubility of at least 1 g/mL @ 25° C., more preferably of at least 1.2 g/mL @ 25° C. The P₂O₅ content of the polyphosphate is preferably between 50 and 70 wt. %, more preferably between 55 and 65 wt. %. The nitrogen content of the polyphosphate is preferably between 15 and 25 wt. %, more preferably between 15 and 20 wt. %. Preferably, the polyphosphate has pH value of between 5.5 and 7.5 for a 1% solution in water (w/v with respect to total solution volume), more preferably between 6.7 and 7.0. Solubility values given are at 25° C. unless defined otherwise.

In addition to the polyphosphate, the core may contain other compounds, for example from the group of phosphates, phosphinates or phosphonates. However, it is preferred if the core contains 50 to 100% by weight of ammonium polyphosphate, particularly preferably 75 to 100% by weight and most preferably 100% by weight.

The shell of the particles comprises polyphenols. Preferably, the polyphenols can be obtained from biomass through extraction, pyrolysis, or fragmentation, and are therefore bio-based. More preferably, the bio-based polyphenols comprise structural units derived from any one or more of water soluble lignins, water soluble tannins, condensed tannins, hydrolysable tannins, phlorotannins, gallic acid, ellagic acid, phloroglucinol, catechins, profisetidin, prorobinetin, gallocatechin, cashew nut shell liquid, 4-hydroxybenzoic 3,4-hydroxybenzoic acid, cafeic acid, 4-hydroxybenzaldehyde, coniferyl alcohol, vanillin, 4-hydroxyacetophenone, and/or acetovanillon. More preferably, the bio-based polyphenols comprise structural units derived from lignin. Even more preferably, the shell of particles comprises kraft lignins or lignosulfonates, most preferably lignosulfonates.

Kraft lignins are by-products from the Kraft process. Lignosulfonates (LS) are sulfonated lignin by-products from the production of wood pulp using sulfite pulping. Due to the presence of the sulfonated group, lignosulfonates are negatively charged and typically water soluble at pH between 6.0-8.0. Lignosulfonates have very broad ranges of number average molecular weight Mn (i.e. they are very polydisperse), for example in the range of from 1,000-140,000 Da. LS are non-toxic, non-corrosive, and biodegradable. Kraft lignin generally has a lower water solubility at pH between 6.0 and 8.0, due to the lower degree of sulfonation. However, Kraft lignins are soluble at basic pH above 8.5.

Preferably, the lignosulfonates have a water solubility at pH between 6.0 and 8.0 of at least 5 wt. %, such as at least 7 wt. %, preferably at least 10 wt. % relative to the weight of the total solution. Preferably, the lignosulfonates have at least 8 mmol/g of hydroxyl groups, more preferably at least 13 mmol/g, such as at least 18 mmol/g. Decomposition reactions between the flame retardant and the polymer matrix are minimized, due to the introduction of the polyphenol shell around the flame retardant. Moreover, the polyphenol shell can decrease the degradation of the final polymer composition during melt processing.

In a preferred embodiment, the shell of the particles is substantially free of melamine, acrylate and silicone. In this case, the term substantially free may be read as being free from any detectable and/or functional amount of melamine, acrylate and silicone. Preferably, the shell comprises less than 100 ppm by weight, more preferably less than 10 ppm by weight, and most preferably less than 1 ppm by weight of melamine, acrylate and silicone.

The particles may also be used as heterogeneous nucleation agents to increase foam properties such as higher cell density and smaller cell size.

The invention also provides a method for producing particles of the invention, the method comprising:
preparing an inverse emulsion of polyphenols, water-soluble flame retardant, emulsifier and water in an organic solvent, subsequently
cross-linking the polyphenol with a crosslinker, and
optionally grafting the cross-linked polyphenol with a further polymer.

For example, the inverse emulsion (i.e. water-in-oil emulsion) may be prepared by first dissolving the polyphenols and water-soluble flame retardant in water, and preparing a solution of the emulsifier in the organic solvent, combining both solutions to form a two-phase mixture, and subsequently emulsifying the two-phase mixture.

When the water-soluble flame retardant is APP, the pH value of the solution in water can be adjusted between 4.0 and 10.0, preferably between 5.0 and 9.0, most preferably between 7.0 and 8.0 by the addition of a base such as sodium hydroxide or an acid such as hydrochlorid acid or sulfuric acid.

Preferably, the amount of the water-soluble flame retardant amounts to 65-95%, such as 66-90%, preferably 67-85% by weight and the amount of the polyphenol to 5-35%, such as 10-34%, preferably 15-33% by weight, based on the total weight of the water-soluble flame retardant and the polyphenols.

In order to obtain a uniform droplet size, emulsification may for example be executed by ultrasonic emulsification, by emulsification with a microfluidizer, or by emulsification with a rotor-stator system.

Cross-linking of the polyphenols to yield the particles of the invention may subsequently be performed by adding a solution of a cross-linker in a second organic solvent, wherein the second organic solvent is miscible with the organic solvent of the inverse emulsion, more preferably wherein the second organic solvent is the same solvent as used for preparing the inverse emulsion.

Due to preparation of particles in an emulsion, particles will have a substantially spherical shape. Thus, preferably, the particles have a substantially spherical shape. By substantially spherical, it is meant that the particles possess a three-dimension geometry resembling a sphere, and the largest diameter does not differ by more than 20 percent, preferably not more than 10 percent, from the smallest diameter, based on the smallest diameter. Thus, the term “substantially spherical” is intended to encompass minor deviations from a perfect sphere, allowing for manufacturing tolerances and other variations, provided that such deviations do not exceed 20 percent, preferably 10 percent, of the smallest diameter. The size distribution of the particles is controllable via 3 parameters. First, the amount of the emulsifier determines the minimum droplet sizes which can be achieved in the emulsification step. Less emulsifier results in larger droplet sizes. The droplet size determines the size of the final particles. Furthermore, the processing parameters during emulsification are of influence. For example, for microfluidization, these parameters are the number of runs, wherein more runs lead to a more uniform particle distribution, and the applied pressure, wherein a higher pressure typically leads to smaller droplets and thus smaller particles. The skilled person knows how to alter the parameters in order to arrive at a desired particle distribution.

The size of the particles is preferably between 50 nm-100 μm, more preferably between 100 nm-1 μm, most preferably between 150 nm-250 nm. Alternatively, the size of the particles may be between 50-500 nm. The size is preferably measured by DLS, for example according to ISO 22412:2008, or by the method disclosed under characterization hereinbelow. Alternatively, the size may be determined by TEM, by measuring the average diameter of the dried particles, for example by the method disclosed under characterization herein below. In case of a particle which is not perfectly spherical, the diameter of a particle as measured by TEM is the largest measured diameter.

Particles with smaller sizes can be added in smaller amounts (by weight) to achieve the desired flame retardant properties as compared to larger particles. Without being bound by theory, it is believed that smaller particles result in a more uniform distribution of the flame retardant, and therefore better flame retardant properties at the same amount of particles. The polydispersity index (PDI) is preferably lower than 0.5, preferably lower than 0.25, most preferably lower than 0.2, such as between 0.05 and 0.15.

The organic solvent is not miscible with water, i.e. preferably has a water solubility of less than 100 g/dm³ of water, more preferably less than 5 g/dm³ of water at 25° C., and is preferably a solvent which is easily separated from the cross-linked particles by evaporation, such as a solvent which has a boiling point at atmospheric pressure below 150° C., preferably below 120° C., and more preferably below 80° C. In a preferred embodiment, the organic solvent is a pentane or mixture of pentanes. Pentanes are used for many polymer foams as the blowing agent of choice. By preparing the particles in pentanes, the process can be easily integrated in a standard large-scale moulding foam or foam extrusion process which is applied on an industrial scale for pentane-expanded polymer particle foams, such as EPS (Expanded Polystyrene) or XPS (Extruded Polystyrene). Most preferably, the organic solvent is n-pentane or cyclopentane.

The hydrophilic-lipophilic balance of an emulsifier is a measure of the degree to which it is hydrophilic or lipophilic, and is defined as HLB=20 Mn/M, wherein Mn is the molecular mass of the hydrophilic portion of the molecule, and M is the molecular mass of the whole molecule, giving a result on a scale of 0 to 20. In principle, any non-ionic emulsifier with an HLB value low enough to generate a stable water-in-oil emulsion may be used as the emulsifier. The emulsifier is preferably added in an amount ranging from 0.1% to 8.0%, more preferably 0.5% to 6%, even more preferably 1.0 to 4.0%, most preferably 1.5% to 3.5% (w/w), based on the amount of organic phase. The emulsifier is preferably an emulsifier with an HLB value of at most 7, more preferably the emulsifier is polyglycerol polyricinoleate (PGPR, E476). Preferably, the PGPR has a polymerization degree of between 1-10, more preferably between 1-4.

The crosslinker is preferably a polyisocyanate, such as an aliphatic, cycloaliphatic, araliphatic, aromatic or heterocyclic polyisocyanate, for example those corresponding to formula (II)

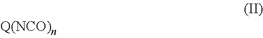

Wherein n is an integer between 2-4, preferably 2 or 3, and Q is an aliphatic hydrocarbon radical having 2-18, preferably 6-10 C atoms, a cycloaliphatic hydrocarbon radical having 4-15, preferably 6-13 C atoms, an aromatic hydrocarbon radical having 6-10 C atoms, or an araliphatic hydrocarbon radical having 8-15, preferably 8-13 C atoms.

Particularly preferred are the technically easily accessible polyisocyanates, e.g. 2,4- and 2,6-toluylene diisocyanate, as well as any mixtures of these isomers (“TDI”); polyphenylpolymethylene polyisocyanates such as are prepared by aniline-formaldehyde condensation followed by phosgenation (“crude MDI”) and polyisocyanates comprising carbodiimide groups, urethane groups, allophanate groups, isocyanurate groups, urea groups or biuret groups (“modified polyisocyanates” or “prepolymers”), in particular modified polyisocyanates which derive from 2,4- and/or 2,6-toluylene diisocyanate and/or from diphenylmethane 4,4′- and/or 2,4 and/or 2,2″-diisocyanate. Preferably, at least one compound selected from the group consisting of 2,4- and 2,6-toluylene diisocyanate, diphenylmethane 4,4′- and 2,4′- and 2,2′-diisocyanate and polyphenylpolymethylene polyisocyanate (“multinuclear MDI”) is used as a crosslinker.

The mixtures of diphenylmethane diisocyanate and polyphenylene polymethylene polyisocyanate (“multinuclear MDI” or “pMDI”) have a preferred monomer content of between 50 and 100 wt. %, preferably between 60 and 95 wt. %, particularly preferably between 75 and 90 wt. %. The NCO content of the polyisocyanate used should preferably be above 25 wt. %, preferably above 30 wt. %, particularly preferably above 31.4 wt. %. Preferably, the MDI used should have a 2,4′-diphenylmethane diisocyanate content of at least 3% by weight, preferably at least 15% by weight.

In addition to the polyisocyanates mentioned above, it is also possible to co-use proportions of modified diisocyanates having uretdione, isocyanurate, urethane, carbodiimide, uretonimine, allophanate, biuret, amide, iminooxadiazinedione and/or oxadiazine trione groups as well as unmodified polyisocyanate with more than 2 NCO groups per molecule, such as 4-isocyanatomethyl-1,8-octane diisocyanate (nonane triisocyanate) or triphenylmethane-4,4′,4″-triisocyanate.

The particles produced after crosslinking the polyphenol with the crosslinker are easily dispersible in polymer matrices with a chemistry that is comparable to that of the polyphenol or the emulsifier.

However, in order to be dispersible in other-especially more polar-polymer matrices, the crosslinked polyphenol may need to be grafted with a further polymer. Thus, the shell of the particles may be grafted with a further polymer.

In this case, oligomers or polymers which are miscible with, preferably identical to, the polymer matrix may be grafted onto the particle surface. This grafting ensures the colloidal stability during the redispersion of the particles in the polymer matrix. Preferably, the oligomers or polymers are OH-functionalized or NH₂-functionalized, most preferably OH-functionalized. Preferably, the weight ratio of solids (i.e. particles including core and shell plus emulsifier) to grafting polymer is about 1:1, such as between 0.5:1 and 2:1, preferably between 0.8:1 and 1.25:1.

In order to produce a flame retardant polymer composition the abovementioned method for producing the particles may be followed by the steps of:
adding matrix polymer, and
removing the organic solvent.

The steps may be executed in the abovementioned order, or the step of removing the organic solvent may precede the step of adding matrix polymer. When the organic solvent is removed first, the remaining particles may be mixed with a thermoplastic matrix polymer, for example in a compound mixer or melt compounding system (with either tangential or intermeshing rotor geometry). Otherwise, an extrusion process (e.g. sheet film extrusion, blown film extrusion, over jacketing extrusion, tubing extrusion, profile extrusion, coextrusion, extrusion coating) can be used to disperse the particles in the polymer matrix and to further process the compositions.

Preferably, the matrix polymer is added before removal of the organic solvent, as this leads to a more uniform particle distribution in the compositions. The matrix polymer is preferably added as a solution in an organic solvent, preferably a solvent that is miscible with the solvent that was used for preparing the inverse emulsion, most preferably the same solvent as was used for preparing the inverse emulsion. For example, in order to produce a flame retardant polylactic acid (PLA) composition, a solution of PLA may be added to the inverse emulsion with crosslinked particles, after which the solvent is evaporated, such as by heating, distillation and/or rotary evaporation, or any other evaporation technique known to the skilled person. The result is a polymer matrix with dispersed flame retardant particles, i.e. a flame retardant polymer composition.

Preferred matrix polymers are flammable polymers, i.e. polymers which do not pass a UL94 test according to ISO 9772:2020 or ISO 9773:1998 and/or polymers with an LOI index lower than 20% according to ISO 4589-2. Especially preferred matrix polymers are liquid polymer resins, such as acrylate, polyurethane acrylate and methacrylate polymers, e.g. acrylated oils, acrylated plant oils, ethoxylated bisphenol A dimethacrylate (Bis-EDA), bisphenol A glycidyl methacrylates (Bis-GMA), Poly-(ethylenglycol)-diacrylate (PEGDA), urethane dimethacrylate (UDMA), triethylene glycol dimethacrylate (TEGDMA), trimethylolpropane triacrylate (TTA). Further preferred matrix polymers are thermoplastic polymers such as polystyrene and derivatives thereof (e.g. crosslinked polystyrenes), polylactic acid (PLA), thermoplastic polyurethanes, polyamides (e.g. PA6), polymethacrylates (e.g. PMMA), polyolefins (e.g. polyethylene (PE), polypropylene (PP)), polyesters, polyethers and/or copolymers and/or blends thereof.

Preferably, the flame retardant polymer composition comprises between 1-50 wt. %, more preferably between 5-25 wt. %, even more preferably between 7-19 wt. %, most preferably between 9-18 wt. % of the particles, based on the total weight of the composition. Preferably, the flame retardant polymer composition comprises at least 5 wt. %, more preferably at least 7 wt. %, even more preferably at least 9 wt. % of the particles.

Alternatively, in order to produce a flame retardant polymer composition, the method for producing the particles may be followed by the steps of:
adding reactive monomer or oligomer A,
removing the organic solvent,
adding a further reactive monomer or oligomer B,
reacting A and B with one another.

This method, in which removal of the organic solvent is executed before the addition of B, is particularly suitable for producing cross-linked flame retardant polymer compositions, such as crosslinked polyurethane compositions. In the latter case, reactive monomer or oligomer A is a compound with hydrogen atoms which are reactive towards isocyanates, and B is a polyisocyanate, such as one of the earlier mentioned polyisocyanates.

This method is also suitable for producing thermoplastic compositions from different bifunctional monomers or oligomers, in which case the step of removing the organic solvent may be performed after the step of reacting A and B.

In order to produce a flame retardant polymer foam, a method for producing a flame retardant polymer composition according to the invention further comprises the step of
adding a blowing agent. The blowing agent may be added at any point in the method, the blowing agent needs not to be added as a final step. Chemical and/or physical blowing agents may be used. In the case of physical blowing agents, it is however preferred to add the blowing agent as a final step.

In some cases, the organic solvent may also serve as a blowing agent, in which cases not all organic solvent needs to be removed in the step of removing the organic solvent. Preferred organic solvent blowing agents are cyclopentane, cyclohexane, n-pentane, n-hexane, or toluene. Pentanes are used for many polymer foams as the preferred blowing agent. By preparing the particles in one of the abovementioned solvents, particularly in pentanes, especially n-pentane or cyclopentane, the process can be easily integrated in a standard large-scale moulding foam process which is applied on an industrial scale for pentane-expanded polymer particle foams, such as EPS (Expanded Polystyrene) or XPS (Extruded Polystyrene).

Chemical blowing agents react with the polymer matrix or with one of the reactive monomers or oligomers to form the blowing gas. For example, water or carboxylic acids and mixtures thereof may be used as chemical blowing agent. In case of polyurethane foam production, these react with isocyanate groups to form the blowing gas, such as in the case of water, carbon dioxide is formed, and in the case of formic acid, for example, carbon dioxide and carbon monoxide are formed. Preferably, at least one compound selected from the group consisting of formic acid, N, N-dialkylcarbamic acid, oxalic acid, malonic acid and ricinoleic acid is used as the carboxylic acid. The ammonium salts of these acids are also suitable. Water is particularly preferred as chemical blowing agent.

Physical blowing agents are for example, low-boiling organic compounds such as hydrocarbons, ethers, ketones, carboxylic acid esters, carbonic acid esters, and halogenated hydrocarbons or CO₂. Organic compounds which have boiling points below 100° C., preferably below 50° C. at atmospheric pressure, are particularly suitable. Examples of such preferably used organic compounds are alkanes, such as n-heptane, n-hexane, n- and iso-pentane, preferably technical mixtures of n- and iso-pentanes, n- and iso-butane and propane, cycloalkanes, such as cyclopentane and/or cyclohexane, ethers, such as furan, dimethyl ether and diethyl ether, ketones, such as acetone and methyl ethyl ketone, carboxylic acid alkyl esters, such as methyl formate, dimethyl oxalate and ethyl acetate, and halogenated hydrocarbons, such as methylene chloride, difluoromethane, trifluoromethane, difluoroethane, tetrafluoroethane, 1,1-dichloro-2,2,2-trifluoroethane, 2,2-dichloro-2-fluoroethane and heptafluoropropane. Also preferred is the use of (hydro) fluorinated olefins, such as HFO 1233zd(E) (trans-1-chloro-3,3,3-trifluoro-1-propene) or HFO 1336mzz(Z) (cis-1,1,1,4,4-hexafluoro-2-butene) or additives such as FA 188 from 3M (1,1,1,2,3,4,5,5-nonafluoro-4-(trifluoromethyl) pent-2-ene). Mixtures of two or more of the above organic compounds can also be used. In this context, the organic compounds may also be used in the form of an emulsion of small droplets.

The methods according to the invention for preparing flame retardant polymer compositions and/or foams may comprise the addition of a further flame retardant. Preferably the further flame retardant contains melamine and/or the further flame retardant does not comprise a halogen-containing compound. Examples of further flame retardants are, for example, melamine, phosphates or phosphonates, such as diethyl ethane phosphonate (DEEP), triethyl phosphate (TEP) and dimethyl propyl phosphonate (DMPP). Other suitable flame retardants include brominated esters, brominated ethers (Ixol) or brominated alcohols such as dibromoneopentyl alcohol, tribromoneopentyl alcohol, tetrabromophthalate diol (DP 54) and PHT-4 diol, as well as chlorinated phosphates such as tris(2-chloroethyl) phosphate, tris(2-chloropropyl) phosphate (TCPP), tris(1,3-dichloropropyl) phosphate, tricresyl phosphate, diphenylcresyl phosphate (DPK), tris(2,3-dibromopropyl) phosphate, tetrakis(2-chloroethyl)ethylene diphosphate, dimethyl methane phosphonate, diethanolaminomethyl phosphonic acid diethyl ester, and commercially available halogen-containing flame retardant polyols.

The methods according to the invention for preparing flame retardant polymer compositions and/or foams may comprise a further step of addition of excipients and/or additives such as
a) catalysts (activators),
b) surface-active additives (surfactants), such as emulsifiers and foam stabilizers, especially those with low emission such as products of the Tegostab® LF series,
c) additives such as reaction retarders (e.g. acid-reacting substances such as hydrochloric acid or organic acid halides), cell regulators (such as kerosenes or fatty alcohols or dimethylpolysiloxanes), pigments, dyes, stabilizers against aging and weathering, plasticizers, fungistatic and bacteriostatic substances, fillers (such as barium sulfate, diatomaceous earth, carbon black or whiting) and release agents.

The invention further provides for a polymer composition or foam produced by a method according to the invention, and use of the polymer composition or foam for the production of flame retardant coatings, textile, furniture upholstery, textile inserts, mattresses, automobile seats and automobile construction parts, headrests, armrests, sponges, headliners, door panels, seat covers, packaging materials or construction elements.

Preferably, the polymer composition or foam according to the invention comprises from 1-25 wt. %, preferably from 4-21 wt. %, more preferably from 5-15 wt. % of the particles according to the invention, based om the total weight of the polymer composition or foam

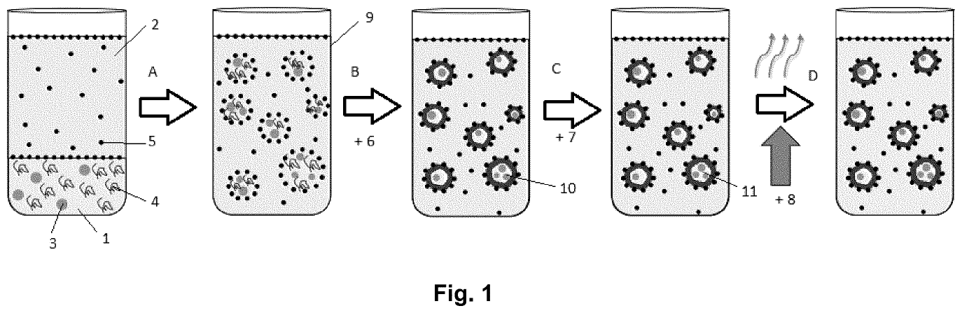

### Detailed Description of FIG. 1

In FIG. 1, a two-phase mixture is prepared from polyphenols 4 and water-soluble flame retardant 3 in water 1, and emulsifier 5 in organic solvent 2. In step A, the two-phase mixture is emulsified to form an inverse emulsion 9. In step B, cross-linker 6 is added to form particles 10. In step C, hydroxyl or amine functionalized monomer, oligomer or polymer 7 is added to form functionalized particles 11. Finally, in step D polymer matrix 8 is added and the solvent is evaporated to form the flame retardant polymer composition.

### Description of the Experiments

### Particle Synthesis

### Raw Materials

Lignosulfonate (TCI, Prod. No.: L0098, #V5VJF-NC), ammonium polyphosphate (APP111, water soluble, Connect Chemicals GmbH, Germany), polyglycerol polyricinoleate (Grinsted PGPR, Danisco, #4012754390, Mat.: 033624), cyclohexane (≥99%, VWR), toluene-2,4-diisocyanate (≥95%, TDI, Sigma Aldrich), toluene (≥99.5%, VWR), 3,6-Dimethyl-1,4-dioxane-2,5-dione (≥99%, Sigma Aldrich), dichloromethane (anhydrous, ≥99.8%, VWR), 1,8-diazabicyclo[5.4.0]undec-7-ene (≥98%, Sigma Aldrich), methanol (anhydrous, ≥99.9% VWR), petroleum ether (≥99%, VWR), polylactic acid (PLA, Natureworks Ingeo 4060D).

### Equipment

Microfluidizer LM10, Branson ultrasonic tip SFX 550, Malvern Zetasizer Lab, rotary evaporator Büchi R200 equipped with a membrane or an oil pump (Büchi V-500 or Edwards RV3), dynamic light scattering Malvern Zetasizer Lab, centrifuges (Hermle Z36HK and Phoenix CD-3124R), scanning electron microscope Hitachi SU8400, transmission electron microscope Zeiss EM91, FT-IR spectrometer (Bruker Alpha-P ATR), thermogravimetric analyzer (TA Instruments TGA550), vacuum oven VOS-12051 (VOS instrumenten) equipped with membrane pump KNF PM23973-920, hotpress (THB 400, Fontijne, Delft, The Netherlands), high-pressure laboratory autoclave (Carl Roth, model II, 200 mL/100 bar), autoclave HMC Hiclave HG50 (HMC Europe GmbH, Germany).

### PGPR Purification

Optionally, PGPR was purified from insoluble aggregates before usage. Therefore, 120 g of PGPR was dissolved in 600 mL of cylcohexane in a 1 L round bottom flask at room temperature. The PGPR solution was then transferred to four 250 mL centrifuge bottles, tared and centrifuged at 9000 rpm for 10 min. The colorless pellet was discarded. The clear supernatant was transferred to a 1 L round bottom flask. The cyclohexane was then completely removed from the solution with a rotary evaporator (40° C., 140 mbar). A clear yellow viscous liquid was obtained.

Dispersion of Particles with an APP Core and Lignin Shell in Cyclohexane

In a 1 L laboratory bottle, the aqueous phase consisting of 15 g lignosulfonate in 195 g water was prepared. After the lignosulfonate was completely dissolved at room temperature, the solution was autoclaved at 121° C. for 40 min and removed from the autoclave. Then, 36 g of ammonium polyphosphate was added to the lignosulfonate solution and dissolved at room temperature. Afterwards, the organic phase consisting of 12 g of purified PGPR and 587 g of cyclohexane was added. Optionally, particle preparation was performed in cyclopentane (566 g, 754 mL) or toluene (653 g, 754 mL) as the organic phase. Subsequently, the two-phase mixture was pre-emulsified on a Branson SFX 250 ultrasonic tip (2 min, 70% amplitude, 30 s sonication, 10 s pause). Any macroscopic precipitates from the pre-emulsion were separated by filtration through an open-pored filter paper. Subsequently, emulsification was performed with the LM10 microfluidizer (6000 psi, 4 runs). This yielded in droplet sizes of 200 nm with a PDI=0.1. The emulsion was then transferred to a 2 L flask and stirred at 500 rpm using a magnetic stirring bar. Freshly prepared crosslinker solution consisting of 3.6 g TDI in 182.9 mL of the organic solvent (either cyclohexane, cyclopentane or toluene) and 1.7 g purified PGPR was added via a 500 mL dropping funnel (approximately 2 drops per second). The dispersion was then stirred at room temperature overnight at 600 rpm using an elliptical stir bar. The next day, stirring was stopped for 2 h and any sedimenting flocculation were decanted and the dispersion was stored in a laboratory bottle, subsequently.

Dispersion of Particles with an APP Core and Lignin Shell in Thermoplastic Matrix (e.g. PLA)

### PLA Oligomer Synthesis

PLA oligomer was synthesized from racemic D,L-lactide by ring opening polymerization with a lactide to initiator ratio of 100:1 corresponding to 200 lactic acid repeating units. A 200 mL Schlenk flask was first purged three times alternating between vacuum and nitrogen. The flask was then flame-dried to remove traces of water. 17 g of racemic D,L-lactide (117.9 mmol) was added to the flask. 90 mL of anhydrous dichloromethane was subsequently added to the flask and the solution was stirred under nitrogen for 1 hour to completely dissolve the monomer. 1 mL of a 0.315 M solution of 1,8-diazabicyclo(5.4.0) undec-7-ene in anhydrous dichloromethane (0.315 mmol) was then added to the flask. 1 mL of a 1.179 M solution of methanol in anhydrous dichloromethane (1.179 mmol) was subsequently added to the flask and the reaction was allowed to proceed for 2 hours under nitrogen at room temperature. The raw product was finally precipitated in 900 mL of petroleum ether and filtered under vacuum. The obtained PLA powder was dried in a vacuum oven at 50° C. overnight.

### PLA Grafting on Lignin Particles (PLA-g-LP)

Toluene was added under stirring to the lignin particle dispersion in cyclohexane in a ratio of 1:1 (v/v). Afterwards, the cyclohexane was evaporated at the rotational evaporator (25° C., 105 mbar). Afterwards, the PLA oligomer was dissolved in toluene at 60° C. (c=4 wt. %). The PLA oligomer solution was cooled to room temperature and was added dropwise to the stirred lignin particle dispersion in toluene. The amount of solids from the dispersion and the amount of PLA oligomer was set to a ratio of 1:1 (wt/wt). Afterwards, the flask was stirred overnight at room temperature to carry out the grafting of PLA oligomers to the lignin particle surface.

### Preparation of PLA Composites

PLA composites containing 5 wt. %, 9 wt. %, 13 wt. % and 20 wt. % APP loaded PLA-g-LP were prepared. PLA was first dissolved in toluene at a concentration of 7.5 wt. % with stirring at 80° C. for one night. The PLA solution was then added dropwise to the stirred lignin particle dispersion in toluene. The obtained mixture was characterized by DLS. Toluene was subsequently evaporated from the mixture by rotary evaporation and the composites were recovered in Petri dishes. The resulting composites were finally dried from remaining toluene residues in the fume hood at room temperature for 24 hours and subsequently in a vacuum oven for 24 hours at 70° C.

### Hot-Pressing of Composites

PLA composites and raw PLA pellets were hot-pressed to prepare sticks with dimensions of I=10 cm, b=0.5 cm, h=1.5 mm sticks. The hot-pressing stages were preheated either to 70° C. for hot-pressing the 20 wt. % APP loaded PLA-g-LP PLA composite or to 80° C. for hot-pressing the other PLA composites and the raw PLA pellets. Small cut pieces of PLA composites or raw PLA pellets were put into a mould with rectangular patterns measuring I=10 cm, b=0.5 cm, h=1.5 mm. PTFE sheets and aluminium plates were inserted between the mould and the upper and lower stages of the hot-press. The samples were initially preheated with a pressure of 20 kN for 40 minutes. The samples were then pressed to 100 kN for 10 minutes. The stages were subsequently cooled to room temperature. The resulting hot-pressed samples were finally removed from the stages and recovered from the mould.

### PLA CO₂ Batch Foaming Process

PLA foams were prepared by enclosing the hot-pressed PLA samples in a high-pressure autoclave at room temperature. The sticks were first sealed in the high-pressure vessel. The vessel was then flushed with CO₂ at low pressure for 30 seconds. The pressure was subsequently increased to 30 bar for foaming the hot-pressed PLA composites or to 40 bar for foaming the hot-pressed raw PLA. CO₂ saturation was performed for 6 hours. The vessel was then depressurized. The samples were removed from the vessel and immersed in a water bath at 60° C. for 10 seconds and subsequently quenched in an ice bath. The resulting foams were finally dried at room temperature. For SEM analysis, foams were further dried over night at 60° C. under vacuum.

### Characterization

### Solid Content of Lignin Particles (LP) Dispersion

200 μL of dispersion of particles with an APP core and lignin shell in cyclohexane was placed into 1 mL glass vials and the solvent was evaporated under vacuum (2 h, 70° C.). Subsequently, the solid content was determined by differential weighing. Typically, solid contents of 5.7±0.3% were reached.

### Dynamic Light Scattering (DLS)

Particle size was measured with a Malvern Zetasizer Lab at a scattering angle of 90° at 25° C. using a general purpose analysis model. 2.5 μL particle dispersion was diluted in 800 μL fresh cyclohexane in a glass cuvette so that the attenuator was at step 10-11 (set automatically by the device). Data analysis was done with ZSxplorer 2.2.0.147 software from Malvern Panalytical. Three measurements were performed for each sample.

### Electron Microscopy of Particles

500 μL of dispersion was centrifuged three times at 1400 g for 30 min in a 1 mL microreaction tube. After each centrifugation, the supernatant was removed and the resulting pellet was redispersed in 500 μL of fresh cyclohexane (30 s vortex and 15 min ultrasonic bath). After the last redispersion, 10 μL of the sample was diluted in 800 μL of fresh cyclohexane. 2 μL of this diluted sample was placed onto a Si wafer or carbon surface, the solvent was evaporated overnight at room temperature. The particles were imaged via SEM subsequently. For TEM imaging, 1 μL of the diluted sample was dropped onto a copper grid and the solvent was evaporated at room temperature.

### Thermogravimetric Analysis (TGA)

2 mg of the dried particle dispersion from cyclohexane was analyzed in a titanium crucible under nitrogen atmosphere in the temperature range 25° C.-600° C., with a heating rate of 10 K min-1.

### Electron Microscopy of Foams

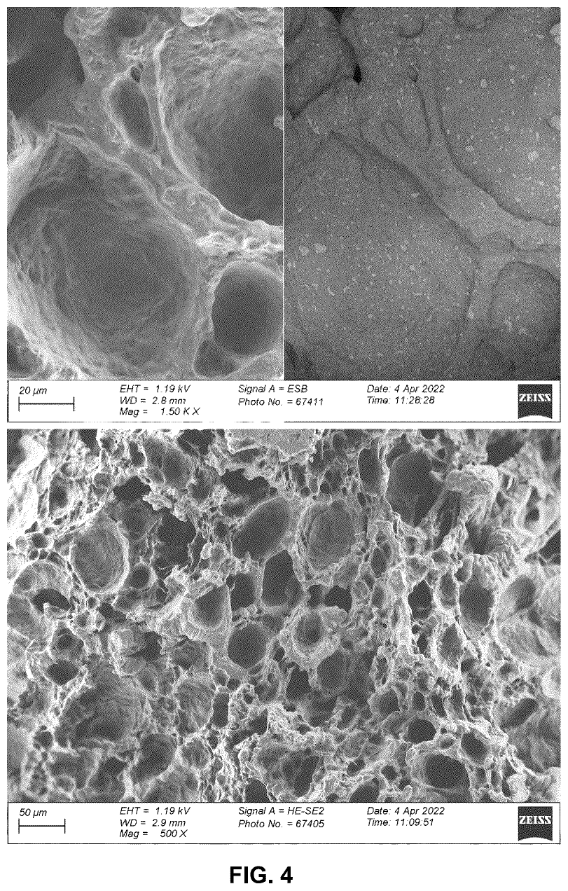

CO₂-blown PLA foams were characterized by secondary electron microscopy (SEM). Therefore, the foams were freeze-fractured after cooling in liquid nitrogen for 10 min prior to SEM imaging. Secondary electron analysis as well as backscattered electron analysis was performed. Imaging parameters are given in FIG. 4.

From the SEM backscattered electron analysis, it can be seen that the particles are homogeneously distributed throughout the foam (FIG. 4)

### Cell Density and Nucleation Efficiency

The cell diameter and the cell density were obtained for each foam by analysing SEM cross-sectional images which include at least 100 cells using ImageJ software. The average cell diameter D was determined directly from SEM cross-sectional images.

### Limiting Oxygen Index (LOI)

The LOI index was determined according to ISO 4589-2.

The LOI represents the minimum level of oxygen in the atmosphere that can sustain a flame on a polymer material.

### UL94 Rating

The UL94 rating was determined according to ISO 9772:220 and ISO 9773:1998

Rating V-2 indicates that burning stops within 30 s after two applications of ten seconds each of a blue Bunsen burner flame, flaming drips are allowed.

Rating V-1 indicates that burning stops within 30 s after two applications of ten seconds each of a blue Bunsen burner flame, non-flaming drips are allowed.

Rating V-0 indicates that burning stops within 10 s after two applications of ten seconds each of a blue Bunsen burner flame, non-flaming drips are allowed.

TABLE 1

| | Char yield at | | | | Ignition of |
|---|---|---|---|---|---|
| | 590° C. by | | UL-94 | UL-94 | cotton |
| Foam | TGA (wt. %) | LOI | (horizontal) | (vertical) | indicator |
| Raw PLA | 0.9 | 21% | failed | failed | Yes |
| 5 wt. % | 2.8 | 23% | HB | V1 | No |
| PLA-g-LP | | | | | |
| 9 wt. % | 4.3 | 24% | HB | V0 | No |
| PLA-g-LP | | | | | |
| 13 wt. % | 5.4 | 24.1% | HB | V0 | No |
| PLA-g-LP | | | | | |
| 20 wt. % | 7.3 | 24.3% | HB | V0 | No |
| PLA-g-LP | | | | | |

From Table 1 it can be seen that 5 wt. % of particles already results in a significantly improved flame retardancy, and that 9 wt. % of particles even results in a V0 rating. In comparison, when PLA is flame retarded by inorganic fillers, such as aluminum tri-hydroxide, a loading as high as 50 wt. % is typically needed to reach a V0 rating (see Bourbigot et al., Polym. Chem. 2010, 1, 1413-1422). In case of phosphates, such as melamine polyphosphate or ammonium phosphate functionalized lignin, 20 wt. % of additive is normally required to achieve a V0 rating in PLA (see Bourbigot et al., Molecular Crystals and Liquid Crystals 486, 2008, 1, 325-339, and Costes et al., European Polymer Journal 2016, 84, 652-667).

The mechanical properties (elongation at break, young's modulus and tensile strength) of the 9 wt. % experiment of Table 1 are evaluated, and found to be comparable to those of raw PLA. The addition of the particles does not significantly influence the mechanical properties of the PLA.

The 9 wt. % experiment of Table 1 is repeated with larger particles (10 μm as measured by TEM). This results in lower UL-94 ratings.

TABLE 2

| Content of | | | | |
|---|---|---|---|---|
| particles | | | Potential | |
| in the PLA- | Mean foam | Foam cell | nucleation | |
| composition/ | cell diameter/ | density/ | density/ | Efficiency/ |
| wt % | μm | cells cm³ | cells cm³ | % |
| 0 | 63 | 2.16 · 10⁷ | — | — |
| 5 | 29 | 4.27 · 10⁸ | 3.39 · 10¹³ | 1.26 · 10⁻⁵ |
| 9 | 26 | 4.49 · 10⁸ | 6.77 · 10¹³ | 6.63 · 10⁻⁶ |
| 13 | 31 | 3.95 · 10⁸ | 1.02 · 10¹⁴ | 3.89 · 10⁻⁶ |
| 20 | 52 | 3.25 · 10⁷ | 3.71 · 10¹⁴ | 8.77 · 10⁻⁸ |

From table 2 it can be seen that 5 wt. % of particles increase the foam cell density by an order of magnitude and reduces the mean foam cell diameter by 46% from 63 μm to 29 μm and that the foam cell diameter and foam cell density stay constant up to 13 wt. % particles.

The invention furthermore relates to the following clauses:
1. Particles comprising a core comprising a water-soluble flame retardant and a shell comprising polyphenols, preferably bio-based polyphenols.
2. Particles according to clause 1, characterized in that the amount of the core of the particles amounts to 65-95% by weight and the amount of the shell amounts to 5-35% by weight, based on the total weight of the core and the shell of the particles.
3. Particles according clause 1 or 2, wherein the particles have a size of between 50 nm-100 μm, more preferably between 100 nm-1 μm, most preferably between 150 nm-250 nm.
4. Particles according to any one of the preceding clauses, wherein the water-soluble flame retardant is a polyphosphate, preferably ammonium polyphosphate, more preferably wherein the ammonium polyphosphate corresponds to formula (I).

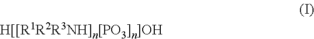

Wherein R¹ to R³ independently represent H or a substituted or unsubstituted alkyl group, preferably an alkyl group having 1 to 8 carbon atoms, and n is an integer from 4 to 20.
5. Particles according to one of the preceding clauses, wherein the shell of the particles comprises polyphenols which comprise structural units derived from lignin, preferably structural units derived from lignosulfonate, more preferably lignosulfonates which have a water solubility at a pH between 6.0 and 8.0 of at least 5 wt %, and/or which have at least 8 mmol/g of hydroxyl groups.
6. Particles according to any one of the preceding clauses, wherein the shell of the particles is grafted with a further polymer.
7. Use of particles according to any one of clauses 1 to 6 as flame retardants.
8. Method for producing particles according to any one of clauses 1 to 6, the method comprising:
   preparing an inverse emulsion of polyphenols, water-soluble flame retardant, emulsifier and water in an organic solvent,
   cross-linking the polyphenol with a crosslinker,
   optionally grafting the cross-linked polyphenol with a further polymer.
9. Method according to clause 8, wherein the organic solvent is chosen from branched or unbranched C₅₋₈ alkanes, C₅₋₈ cycloalkanes and C₅₋₈ aromatics, more preferably wherein the organic solvent is cyclopentane, cyclohexane, n-pentane, n-hexane, or toluene, most preferably wherein the organic solvent is cyclopentane or n-pentane.
10. Method for producing a flame retardant polymer composition, comprising the method of clause 8 or 9 followed by the steps of:
   adding matrix polymer, and
   removing the organic solvent.
11. Method according to clause 10, wherein the step of removing the organic solvent precedes the step of adding matrix polymer, and wherein the particles are mixed with a thermoplastic matrix polymer, preferably in a compound mixing process, extrusion process or injection moulding process.
12. Method for producing a flame retardant polymer composition, comprising the method of clause 8 or 9 followed by the steps of:
   adding reactive monomer or oligomer A,
   removing the organic solvent,
   adding a further reactive monomer or oligomer B,
   reacting A and B with one another.
13. Method for producing a flame retardant polymer foam, comprising the method of any one of clauses 10-12, further comprising the step of adding a blowing agent.
14. Polymer composition or foam produced by the method according to any one of clauses 8-13.
15. Use of a polymer composition or foam according to clause 14 for the production of flame retardant coatings, textile, furniture upholstery, textile inserts, mattresses, automobile seats, headrests, armrests, sponges, headliners, door panels, seat covers or construction elements.

What is claimed is:

1. Particles, comprising:
a core comprising a water-soluble flame retardant, and
a shell comprising polyphenols, preferably bio-based polyphenols,
wherein the particles have a size of between 100 nm-1 μm as measured by DLS, and
wherein the water-soluble flame retardant has a water solubility of at least 1 g/ml @ 25° C.

2. The particles according to claim 1, wherein the amount of the core of the particles amounts to 65-95% by weight and the amount of the shell amounts to 5-35% by weight, based on the total weight of the core and the shell of the particles.

3. The particles according claim 1, wherein the particles have a size of between 150 nm-250 nm.

4. The particles according to claim 1, wherein the water-soluble flame retardant is a polyphosphate, preferably ammonium polyphosphate, more preferably wherein the ammonium polyphosphate corresponds to formula (I). 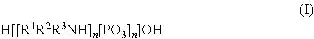
wherein
R¹ to R³ independently represent H or a substituted or unsubstituted alkyl group, preferably an alkyl group having 1 to 8 carbon atoms, and
n is an integer from 4 to 20.

5. The particles according to claim 1, wherein the shell of the particles comprises polyphenols which comprise structural units derived from lignin, preferably structural units derived from lignosulfonate, more preferably lignosulfonates which have a water solubility at a pH between 6.0 and 8.0 of at least 5 wt %, and/or which have at least 8 mmol/g of hydroxyl groups.

6. The particles according to claim 1, wherein the shell of the particles is grafted with a further polymer.

7. A use of particles according to claim 1 as flame retardants.

8. A method for producing particles according to claim 1, the method comprising:
preparing an inverse emulsion of polyphenols, water-soluble flame retardant, emulsifier and water in an organic solvent,
cross-linking the polyphenol with a crosslinker,
optionally grafting the cross-linked polyphenol with a further polymer.

9. The method according to claim 8, wherein the organic solvent is chosen from branched or unbranched C₅₋₈ alkanes, C₅₋₈ cycloalkanes and C₅₋₈ aromatics, more preferably wherein the organic solvent is cyclopentane, cyclohexane, n-pentane, n-hexane, or toluene, most preferably wherein the organic solvent is cyclopentane or n-pentane.

10. A method for producing a flame retardant polymer composition, comprising the method of claim 8 followed by the steps of:
adding matrix polymer, and
removing the organic solvent.

11. A method according to claim 10, wherein the step of removing the organic solvent precedes the step of adding matrix polymer, and wherein the particles are mixed with a thermoplastic matrix polymer, preferably in a compound mixing process, extrusion process or injection moulding process.

12. A method for producing a flame retardant polymer composition, comprising the method of claim 8 followed by the steps of:
adding reactive monomer or oligomer A,
removing the organic solvent,
adding a further reactive monomer or oligomer B,
reacting A and B with one another.

13. A method for producing a flame retardant polymer foam,
comprising the method of claim 10, further comprising the step of adding a blowing agent.

14. A polymer composition or foam produced by the method according to claim 8.

15. A use of a polymer composition or foam according to claim 14 for the production of flame retardant coatings, textile, furniture upholstery, textile inserts, mattresses, automobile seats, headrests, armrests, sponges, headliners, door panels, seat covers or construction elements.

16. Particles according to claim 1, characterized in that the amount of the core of the particles amounts to 65-95% by weight and the amount of the shell amounts to 5-35% by weight, based on the total weight of the core and the shell of the particles and wherein the particles have a size of between 150 nm-250 nm and wherein the water-soluble flame retardant is a polyphosphate, preferably ammonium polyphosphate, more preferably wherein the ammonium polyphosphate corresponds to formula (I). 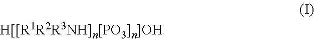
wherein
R¹ to R³ independently represent H or a substituted or unsubstituted alkyl group,
preferably an alkyl group having 1 to 8 carbon atoms, and
n is an integer from 4 to 20.
and wherein the shell of the particles comprises polyphenols which comprise structural units derived from lignin, preferably structural units derived from lignosulfonate, more preferably lignosulfonates which have a water solubility at a pH between 6.0 and 8.0 of at least 5 wt %, and/or which have at least 8 mmol/g of hydroxyl groups and wherein the shell of the particles is grafted with a further polymer.

17. The use of particles according to claim 16 as flame retardants.

18. The method for producing particles according to claim 16, the method comprising:
preparing an inverse emulsion of polyphenols, water-soluble flame retardant, emulsifier and water in an organic solvent,
cross-linking the polyphenol with a crosslinker,
optionally grafting the cross-linked polyphenol with a further polymer,
adding matrix polymer, and
removing the organic solvent,
wherein the organic solvent is chosen from branched or unbranched C₅₋₈ alkanes, C₆₋₈ cycloalkanes and C₅₋₈ aromatics, more preferably wherein the organic solvent is cyclopentane, cyclohexane, n-pentane, n-hexane, or toluene, most preferably wherein the organic solvent is cyclopentane or n-pentane.

19. The method according to claim 18, wherein the step of removing the organic solvent precedes the step of adding matrix polymer, and wherein the particles are mixed with a thermoplastic matrix polymer, preferably in a compound mixing process, extrusion process or injection moulding process.

20. The polymer composition or foam produced by the method according to claim 18.

21. The use of a polymer composition or foam according to claim 20 for the production of flame retardant coatings, textile, furniture upholstery, textile inserts, mattresses, automobile seats, headrests, armrests, sponges, headliners, door panels, seat covers or construction elements.
